(19) United States
(12) Patent Application Publication
(10) Pub. No.: US 2005/0051986 A1
(43) Pub. Date: Mar. 10, 2005

(54) Trailing arm suspension with optimized i-beam

(76) Inventors: Gregory T. Galazin, Montague, MI (US); Daniel R. Dykstra, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/503,273

(22) PCT Filed: Jan. 31, 2003
(86) PCT No.: PCT/US03/03010

(30) Foreign Application Priority Data
Feb. 1, 2002 (US) 60353629

(51) Int. Cl. B60G 1/00

(52) U.S. Cl. 280/124.116

(57) ABSTRACT

A suspension system includes a pair of trailing arms (112) extending between frame brackets (18) and a wheel-carrying axle (22). Each trailing arm (112) comrises an I-beam portion having a web section and first and second flanges, wherein the thickness of at least one of the flanges vaires along a length thereof. The trailing arms (112) are welded directly to the axle (22).

### BACKGROUND OF THE INVENTION

1. Field of the Invention

The invention relates to vehicle suspension systems, and in particular to suspensions for semi tractor-trails incorporating single-piece, cast trailing arms.

2. Description of the Related Art

Trailing beam suspensions for semi tractor-trailer combinations are well-known in the trucking industry. The typical trailing beam suspension comprises a hanger bracket suspended from a trailer frame rail. A trailing beam or arm is pivotably connected at one end to the hanger bracket to enable the trailing beam to pivot about a horizontal axis. The pivotable connection may comprise a resiliently bushed connection. The free end of the trailing beam is attached to a spring that is, in turn, attached to the trailer frame rail for cushioning the ride. The spring can comprise a mechanical spring, such as a coil spring, or an air spring. An axle is attached transversely to a pair of trailing beams on either side of the trailer through a rigid or resilient axle-to-beam connection. Other suspension and braking components can be attached to the trailing beam and/or the axle, such as a brake assembly, track bars, and shock absorbers.

Trailing beams can take a variety of shapes and cross sections, and are typically fabricated by welding individual components into the final assembly, thereby providing a beam with a hollow cross section. An example of such a beam is disclosed in U.S. Pat. No. 5,366,237 to Dilling et al. Such beams are typically designed for the maximum stress to which the beam will be subjected at any point on the beam. This approach results in sections of the beam having more material than is necessary for the maximum stress imposed on the beam at that section. This excess material adds to the cost and weight of the beam. Furthermore, the welds induce stresses into the beam that can contribute to premature failure of the beam. Weld-induced stresses can be minimized by laying down welds that are of a consistent thickness. However, such detailed welding techniques can also increase the cost of fabrication and the weight.

Attachment of the axle to the beam is typically through some type of welded connection, such as disclosed in U.S. Pat. No. 5,366,237 to Dilling et al. Welded connections can induce in the axle stresses and cracks that can contribute to premature failure of the axle. Weld-induced axle stresses can be minimized by limiting the welded area to the region around the axle's neutral axis, and by starting and ending the weld at the same point on the axle. Moreover, the extent and location of the weld can preclude separation of the axle from the beam, which would be desirable in order to replace a damaged axle or beam without replacing the entire suspension.

Cast suspension beams have been used heretofore in truck and trailer suspension by the Holland Group, Inc. and its predecessors in a variety of suspension systems. For example, the Neway/Anchorlok Master Parts Catalog, dated Nov. 1, 1992, discloses on page 108, an AR-80-9FM trailing arm suspension with a cast suspension beam. Cast equalizer beams have also been used in tandem mechanical suspensions and are disclosed in the Neway/Anchorlok Master Parts Catalog on pages 269 and 246. An example of a cast spring beam in a spring suspension is disclosed in the Neway/Anchorlok Master Parts Catalog on page 262. A mechanical tri-axle spring suspension with a cast beam is disclosed in the Neway/Anchorlok Master Parts Catalog on page 262. A truck/tractor air suspension (ARDAB-120-5 and 240-5) with a forged I-beam is disclosed on page 160 of the Neway/Anchorlok Master Parts Catalog. The forged I-beam mounts an axle through two bushed pin connections.

### SUMMARY OF THE INVENTION

One aspect of the present invention is to provide a suspension system for suspending a vehicle frame above a plurality of ground-engaging wheels that includes a wheel-carrying axle having a first end and a second end, and a pair of frame bracket assemblies operably coupled to opposite sides of the vehicle frame. The suspension system also includes a pair of trailing arm assemblies adapted to be mounted to opposite sides of the vehicle frame and operably coupled to the first end and the second end of the axle, and operably coupled to the frame bracket assemblies, wherein each trailing arm assemblies adapted to be mounted to opposite sides of the vehicle frame and operable coupled to the first end and the second end of the axle, and operably coupled to the frame bracket assemblies, wherein each trailing arm assembly comprises a trailing arm that comprises an I-beam portion having a web section, a first flange and a second flange, wherein a thickness of the first flange varies along a length thereof, and an axle mounting assembly operably coupling the axle to the trailing arms.

Another aspect of the present invention is to provide a trailing arm for use in a vehicle suspension system that includes a first end comprising an axle seat adapted to operably couple with the vehicle axle, and a second end adapted to pivotally couple with a hanger bracket. The trailing arm also includes a longitudinally-extending first flange having a thickness that varies along a length thereof, a longitudinally-extending second flange, and a web section extending between and substantially orthogonal to the first flange and the second flange.

Yet another aspect of the present invention is to provide a suspension system for suspending a vehicle frame above a plurality of ground-engaging wheels that includes a wheel-carrying axle having a first end and a second end, and a pair of frame bracket assemblies operably coupled to opposite sides of the vehicle frame. The suspension system also includes a pair of trailing arm assemblies, wherein each trailing arm assembly is adapted to be mounted to opposite sides of the vehicle frame and operably coupled to the first end and the second end of the axle, respectively, and operably coupled to the frame bracket assemblies, and wherein each trailing arm assembly comprises a trailing arm comprising an I-beam portion having a web section, a first flange and a second flange. The suspension system further includes an axle mounting assembly comprising at least one welded trailing arm-to-axle connection.

Still yet another aspect of the present invention is to provide a trailing arm for use in a vehicle suspension system that includes a first end comprising an axle seat adapted to be directly attached to a vehicle axle, and a second end adapted to pivotably couple with a hanger bracket. The trailing arm also includes an I-beam portion having a longitudinally-extending first flange, a longitudinally-extending second flange, and a web section extending between and substantially orthogonal to the first flange and the second flange.

Another aspect of the present invention is to provide a suspension system for suspending a vehicle frame assembly above a plurality of ground-engaging wheels, the vehicle frame assembly including an external dock lock assembly operable between a storage position and an in-use position, the suspension system including a wheel-carrying axle having a first end and a second end, and a pair of frame bracket assemblies operably coupled to opposite sides of the vehicle frame. The suspension system also includes a pair of trailing arm assemblies, wherein each trailing arm assembly is adapted to be mounted to opposite sides of the vehicle frame and operably coupled to the first end and the second end of the axle, respectively, and wherein each trailing arm assembly is operably coupled to the frame bracket assemblies, respectively. Each trailing arm assembly includes a trailing arm that comprises a longitudinally-extending first flange, and longitudinally-extending second flange, and a web section extending between the first flange and the second flange and having a structurally reinforced section positioned along the length of the trailing aim such that the external dock lock abuts the trailing arm proximate the structurally reinforced section when the external dock lock is in the in-use position.

Still yet another aspect of the present invention is to provide a trailing arm for use in a vehicle suspension system for suspending a vehicle frame assembly above a plurality of ground-engaging wheels, wherein the vehicle frame assembly includes an external dock lock assembly operable between a storage position and an in-use position, the trailing arm including a first end comprising an axle seat adapted to operably couple with a vehicle axle, and a second end adapted to pivotally couple with a hanger bracket. The trailing arm also includes a longitudinally-extending first flange, a longitudinally-extending second flange, and a web section extending between the first flange and the second flange and having a structurally reinforced section positioned along a length of the trailing arms such that the external dock lock abuts the trailing arm proximate the structurally reinforced section when the external dock lock is in the in-use position.

Still yet another aspect of the present invention is to provide a suspension system for suspending a vehicle frame assembly above a plurality of ground-engaging wheels, wherein the vehicle frame assembly includes an external dock lock assembly operable between a storage position and an in-use position, the suspension system including a wheel-carrying axle having a first end and a second end and a pair of frame bracket assemblies operably coupled to opposite sides of the vehicle frame. The suspension system also includes a pair of trailing arms comprising a first end comprising an axle seat that is directly connected to the axle, and a second end adapted to pivotally couple with the hanger bracket. The trailing arm also includes a longitudinally-extending first flange, wherein the thickness of the first flange varies along a length thereof, a longitudinally-extending second flange, wherein the thickness of the second flange varies along a length thereof, and a web section extending between the first flange and the second flange and having a structurally reinforced section positioned along a length of the trailing arm such that the external dock lock abuts the trailing arm proximate the structural reinforced section when the external dock lock is in the in-use position. Each trailing arm is constructed as a single-piece casting.

According to the invention, the shape of the trailing arm or beam designed to accommodate the stresses along the length and height of the trailing arm. Thus, the cross section area of the trailing arm varies along the length of the trailing arm to precisely follow the demands of the trailing aim in service without any significant excess material, thereby optimizing its strength-to-weight ratio. Preferably, the shape of the trailing arm is determined by computer analysis, preferably finite element analysis.

The design approach results in the trailing arm configuration at any section being precisely tailored to the design stress to which the beam will be subjected at that section, reducing the trailing arm material to only that necessary at each section and economizing on weight and cost. Casting the trailing arm, rather than assembling the beam from individual components that are welded together, is the preferred fabrication method as it readily enables the precise beam dimensions determined from the design process to be achieved in the beam as fabricated.

### BRIEF DESCRIPTION OF THE DRAWINGS

In the drawings:

FIG. 1 is an elevational view from the side of a portion of a trailer having a suspension assembly according to the invention;

FIG. 2 is a top perspective view of the suspension assembly shown in FIG. 1;

FIG. 3 is an elevational view from the side of a first embodiment of an I-beam trailing arm;

FIG. 4 is a bottom perspective view of the beam of the I-beam trailing arm;

FIG. 5 is a cross-sectional view of the I-beam trailing arm, taken along line 5-5, FIG. 3;

FIG. 6 is an enlarged bottom perspective view of an axle seat of the I-beam trailing arm;

FIG. 7 is an enlarged side view of an assembly of the axle seat of the I-beam trailing arm shown in FIG. 3 and an axle, showing a portion of the welds used to connect the axle to the trailing arm;

FIG. 8 is an enlarged top perspective view of the assembly of the axle seat and axle shown in FIG. 7 showing a portion of the welds used to connect the axle to the beam;

FIG. 9 is a perspective view of a second embodiment of the I-beam trailing arm according to the invention;

FIG. 10 is a side elevational view of the second embodiment of the I-beam trailing arm;

FIG. 11 is a bottom perspective view of the second embodiment of the I-beam trailing arm;

FIG. 12 is an enlarged top perspective view of the second embodiment of the I-beam trailing arm; and

FIG. 13 is a cross-sectional view of the second embodiment of the I-beam trailing arm, taken along line 13-13, FIG. 10, showing an axle connected to the beam using a welded connection.

### DETAILED DESCRIPTION OF THE PREFERRED EMBODIMENTS

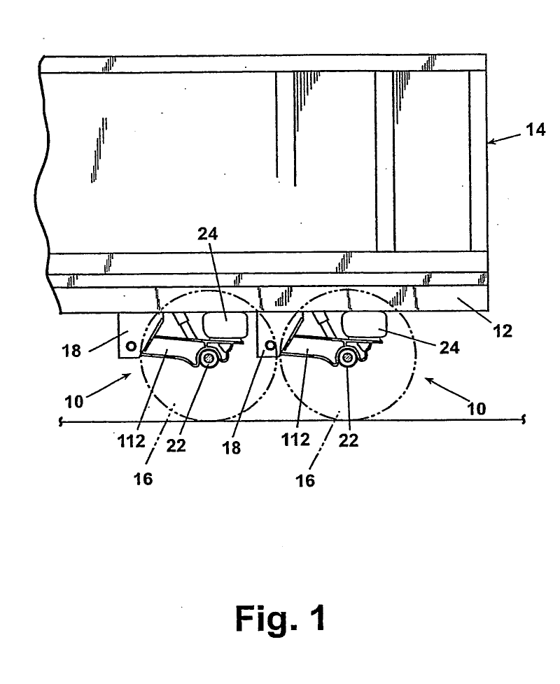

For purposes of description herein, the terms “upper,” “lower,” “right,” “left,” “rear,” “front,” “vertical,” “horizontal,” and derivatives thereof shall relate to the invention as oriented in FIGS. 1-3. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

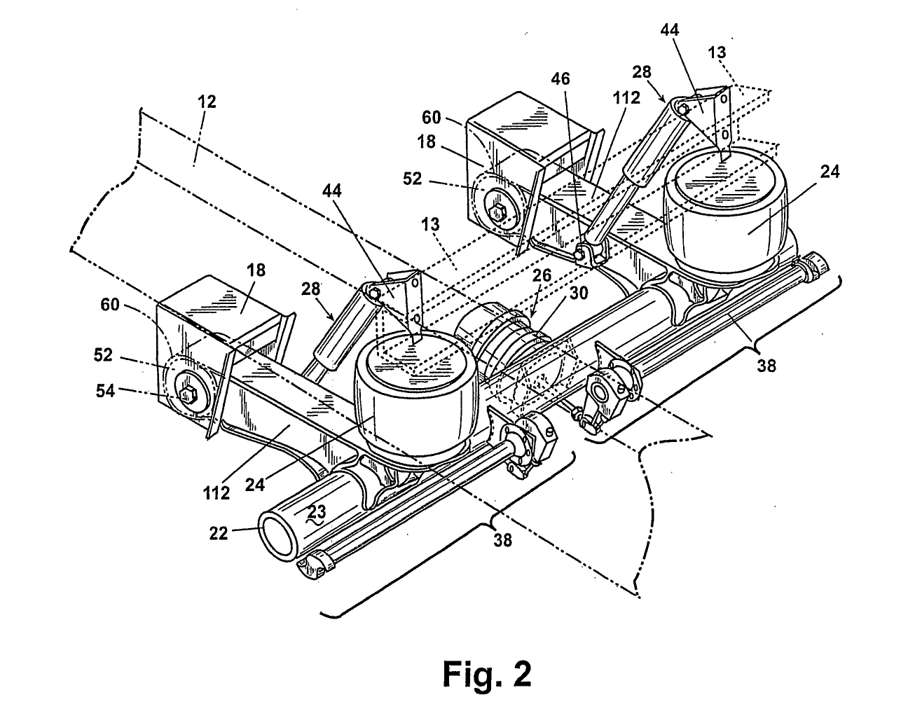

Referring now to FIG. 1, a trailing arm suspension assembly 10 according to the invention is shown suspended from a trailer frame rail 12 which supports a trailer 14. Two identical suspension assemblies 10 are mounted in tandem to the trailer frame rail 12 for supporting the trailer 14 on two sets of wheels 16. The suspension assembly 10 comprises an improved trailing arm or beam 112 suspended at a first end from the trailer frame rail 12 through a hanger bracket 18. A conventional air spring 24 is attached to a second end of the trailing arm 112 and to the trailer frame rail 12. The trailing arm 112 is rigidly connected near its second end to a conventional axle 22 to which wheels 16 (shown in outline) are connected at opposite ends of the axle 22. The axle 22 has an exterior axle surface 23. In a typical trailer application, the two identical trailing arm assemblies are used on either side of the trailer 14 to mount the axle 22 to the frame rail 12 and support opposing ends of the axle 22, as shown in FIG. 2.

The trailing arm assembly 10 (FIG. 2) according to the invention comprises a conventional hanger bracket 18 rigidly connected, such as by bolts, to the trailer frame rail 12 (shown in outline). The trailing arm 112 is resiliently and pivotably connected at a first end to the hanger bracket 18 through a tri-functional resilient bushing 52, such as disclosed in U.S. Pat. No. 4,166,640 to Van Denberg. In the preferred embodiment, the resilient bushing 52 provides for deflection of the trailing arm 112 relative to the hanger bracket 18 that is a different magnitude along the longitudinal axis of the trailing arm 112 than along the axis of the hanger bracket 18. A conventional air spring 24 is mounted between a second end of the trailing arm 112 and the trailer frame rail 12 in a conventional manner, such as with bolted connections. Alternatively, the air spring 24 can be mounted between a central portion of the trailing arm 112 and the trailer frame rail 12 with the axle 22 mounted at the second end of the trailing arm 112.

A conventional shock absorber assembly 28 is preferably mounted between the trailing arm 112 and the trailer frame. In the illustrated example, the shock absorber assembly 28 comprises shock absorber 48 mounted at a first end through a shock absorber bracket 44 to a trailer frame crossbeam 13 (shown in outline) and at a second end through a shock absorber clevis 46 to the trailing arm 112. The clevis 46 is fixedly connected to the trailing arm 112 via welding and the like. The trailing arm assembly 10 can also be selectively provided with a conventional drum brake actuator assembly 26 comprising a brake actuator 30 and an S-cam assembly 38. The brake actuator assembly 26 can be mounted to the axle 22 through appropriate brackets attached thereto, such as by welding. Alternatively, the brake actuator assembly 26 can be mounted to the trailing beam 112, thereby eliminating the axle welds. As well, the suspension assembly can be provided with a conventional disc brake assembly and disc brakes, rather than drum brakes.

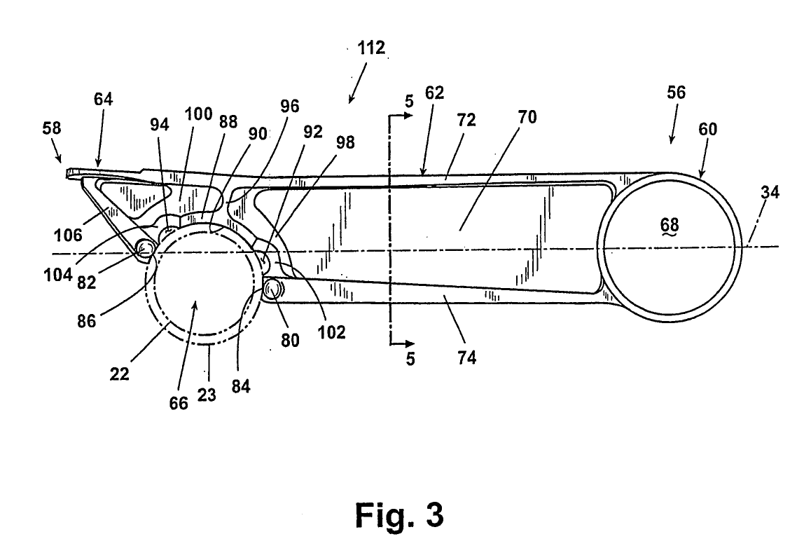

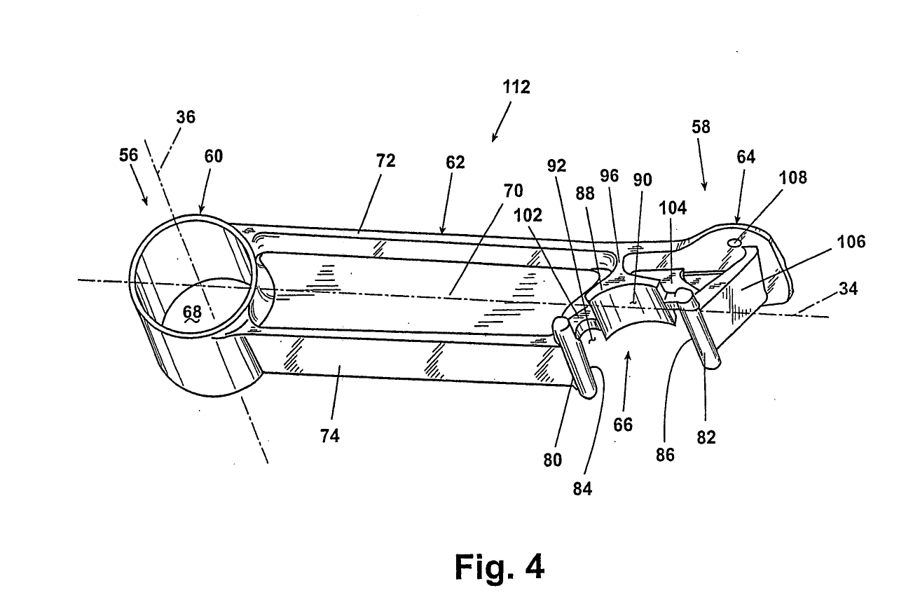

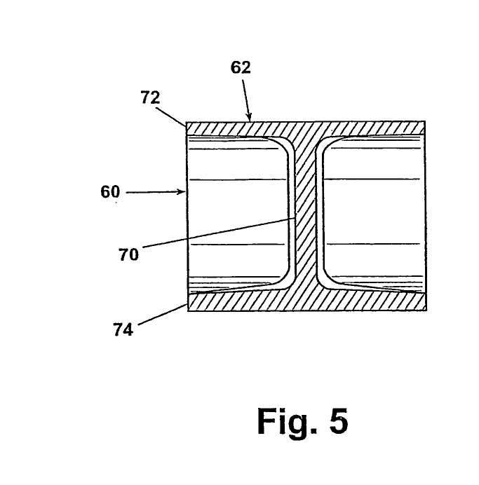

The trailing arm (FIGS. 3-6) is a rigid, generally elongated member having a proximal end 56 and a distal end 58, and a longitudinal axis 34 (FIG. 4). The proximal end 56 comprises a hollow cylindrical bushing sleeve 60 having a bushing aperture 68 and defining a central axis 36 orthogonal to the longitudinal axis 34 (FIG. 4). The distal end 58 comprises an air spring seat 64 and an axle seat 66 adapted for rigid connection of the axle 22. Intermediate the proximal end 56 (FIGS. 3 and 5) and the distal end 58, the trailing arm 112 has an I-beam section 62 comprising a web 70, an upper beam flange 72, and a lower beam flange 74. The plane of the web 70 is generally orthogonal to the central axis 36 of the bushing aperture 68 and coplanar with the longitudinal axis 34 of the trailing arm 112.

In the preferred embodiment, the upper flange 72 extends laterally an equal distance on either side of the web 70 and orthogonally thereto. However, the flange 72 can extend beyond the web 70 an unequal distance to accommodate the stresses in the flange, or due to other considerations such as providing clearance to accommodate other suspension components or the incorporation of mounting structures. As best illustrated in FIG. 3, the upper flange 72 varies in thickness along the length of the trailing arm 112 generally increasing in thickness from the bushing sleeve 60 to the air spring seat 64. As well, the upper flange 72 width can vary depending upon the variation in design stresses along the flange and the size of the trailing arm. For example, the upper flange width of a 53-pound beam approximately 29¼ inches long overall with an approximately 5-inch I-beam depth can vary from 4 inches at approximately the mid-point of the trailing arm 112 to approximately 3 inches adjacent the bushing sleeve 60.

In the preferred embodiment, the lower flange 74 also extends laterally an equal distance on either side of the web 70 and orthogonally thereto, although the flange 74 can extend beyond the web 70 an unequal distance as discussed above. As best illustrated in FIG. 3, the lower flange 84 varies in thickness along the trailing arm 112, generally increasing in thickness from the bushing sleeve 60 to the axle seat 66. The flange thickness will be dependent upon the variation in design stresses along the flange and the size of the trailing arm. For example, the lower flange thickness of a 53-pound beam approximately 29¼ inches long overall with an approximately 5-inch I-beam depth can vary uniformly from about 1 inch adjacent the axle seat 66 to approximately ⅓ inch adjacent the bushing sleeve 60.

The air spring 64 is a generally platelike extension of the upper beam flange 72, generally coplaner therewith, and extending laterally beyond the upper flange 72 to provide a suitable seat for mounting and support of an air spring 24. The air spring seat 64 is provided with a plurality of air spring seat mounting apertures 108 for mounting the air spring 24 to the trailing arm 112 using conventional fasteners, such as bolted connections.

The axle seat 66 is formed in the distal end 58 of the beam 20 and adapted to conform to the axle surface 23. The axle seat 66 comprises a front welding stud 80, a rear welding stud 82, and an axle saddle 88. The front welding stud 80 is an elongated, generally rodlike member preferably extending laterally an equal distance on either side of the beam longitudinal axis 34. However, the stud 80 can extend beyond the axis 34 an unequal distance to accommodate the actual stresses to which the stud 80 will be subjected. The front welding stud 80 has a front axle contact surface 84 for contacting the axle surface 23. The rear welding stud 82 is an elongated, generally rodlike member preferably extending laterally an equal distance on either side of the trailing arm 112 longitudinal axis 34. However, the stud 82 can extend beyond the axis 34 an unequal distance to accommodate the actual stresses to which the stud 82 will be subjected. The rear welding stud 82 has a rear axle contact surface 86 for contacting the axle surface 23. The front welding stud 80 is fabricated as a lateral extension of the lower flange 74 to provide structural, stress-transferring continuity between the stud 80 and the flange 74.

The axle saddle 88 is a generally arcuate, saddle-like structure preferably extending laterally an equal distance on either side of the beam longitudinal axis 34. However, the saddle 88 can extend beyond the axis 34 an unequal distance to accommodate the actual stresses to which the saddle 88 will be subjected. The axle saddle 88 has an axle saddle contact surface 90 with a curvature somewhat greater than the curvature of the axle surface 23. The design process preferably utilizes the finite element analysis method in order to configure the length, width, and thickness of the axle saddle 88 to accommodate the stresses to which the axle saddle 88 will be subjected. In the embodiment shown in FIGS. 3-7, the width of the axle saddle 88 is approximately equal to the width of the upper beam flange 72.

Extending between the axle saddle 88 and the front welding stud 80 is a thickened front web portion 102 with a generally arcuate indentation defining a front welding cavity 92. Extending between the axle saddle 88 and the rear welding stud 82 is a thickened rear web portion 104 with a generally arcuate indentation defining a rear welding cavity 94.

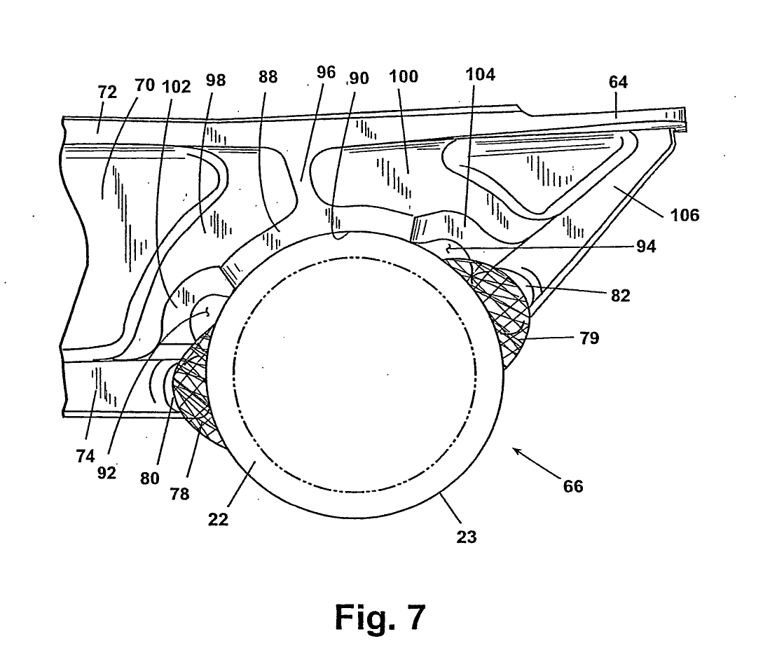

The web 70 is generally a consistent thickness between the bushing sleeve 60 and the axle seat 66. However, as shown in FIGS. 3 and 7, the web 70 becomes progressively thicker proximate to the axle seat 66 to accommodate working stresses concentrated in this portion of the beam 20. Based upon the results of the design process, the web 70 is thickened into a first thickened front web portion 98 and a first thickened rear web portion 100. Immediately adjacent the welding cavities 92, 94, the web 70 is further thickened into the second thickened front web portion 102 and the second thickened rear web portion 104. The design process preferably utilizes the finite element analysis method in order to precisely configure the shape and thickness of the thickened web portions 98, 100, 102, 104 to accommodate the stresses to which the beam web 70 proximate to the axle seat 66 will be subjected.

In the preferred embodiment, the trailing arm 112 is fabricated using generally conventional casting methods. The configuration of the trailing arm 112 is precisely determined, preferably by finite element analysis, accordingly to the design stresses to which the trailing arm 112 will be subjected at every point in the trailing arm 112. Thus, excess material is eliminated, reducing weight and cost, and optimizing the beam's strength-to-weight ratio. The use of casting methods enables the trailing arm 112 to be readily fabricated having the precisely-determined dimensions established from the design process. However, other fabrication methods can be utilized that will provide a beam having a variable cross section corresponding closely to the dimensions established during the design process to maintain the optimized strength-to-weight ratio.

An axle saddle stiffening rib 96 extends between the axle saddle 88 and the upper flange 72. The axle saddle stiffening rib 96 extends generally the same distance laterally of the beam longitudinal axis 34 as the upper flange 72 and the axle saddle 88. The design process preferably utilizes the finite element analysis method in order to precisely configure the shape and thickness of the axle saddle stiffening rib 96 to accommodate the stresses to which the rib 96 will be subjected.

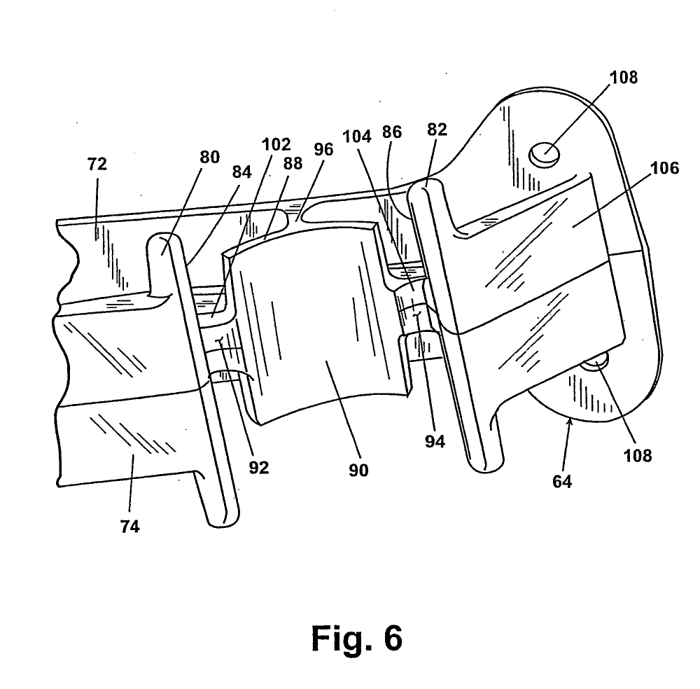

Extending in a generally upwardly-inclined direction from the rear welding stud 82 and the air spring seat 64 is an air spring seat reinforcing flange 106, as shown in FIG. 3. As shown in FIGS. 4 and 6, the air spring seat reinforcing flange 106 is a generally platelike structure with a width approximately equal to that of the flanges 72, 74. The air spring seat reinforcing flange 106 is rigidly connected to the beam web 70 and preferably extends an equal distance laterally of the beam longitudinal axis 34. However, the flange 106 can extend beyond the axis 34 an unequal distance to accommodate the actual stresses to which the flange 106 will be subjected, or due to the other considerations such as providing clearance to accommodate other suspension components or the incorporation of other mounting structures. As shown in FIG. 3, the thickness of the air spring seat reinforcing flange 106 decreases somewhat from the welding stud 82 to the air spring seat 64. The design process preferably utilizes the finite element analysis method in order to precisely configure the shape and thickness of the air spring seat reinforcing flange 106 to accommodate the stresses to which the flange 106 will be subjected. For example, the thickness of the air spring seat reinforcing flange 106 for a 53-pound beam approximately 29¼ inches long overall with an approximately 5-inch I-beam depth can vary uniformly from about 1 inch adjacent the rear welding stud 82 to approximately ⅓ inch adjacent the air spring seat 64.

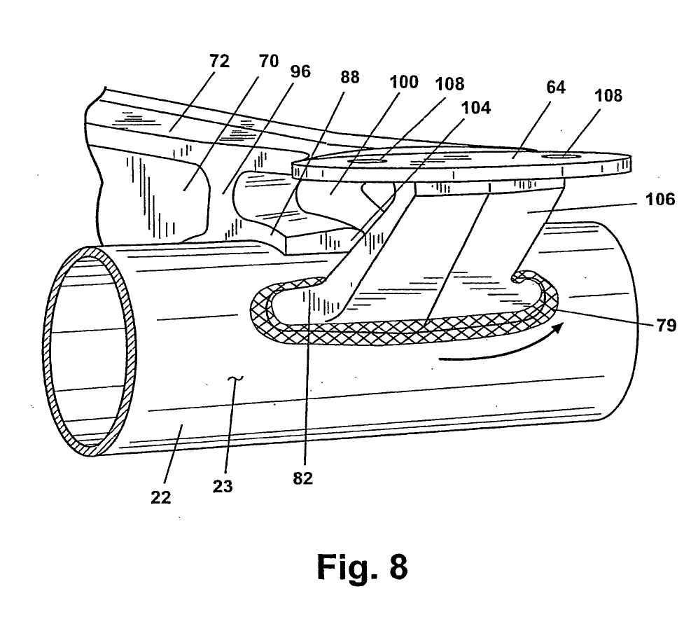

Referring now to FIGS. 7 and 8, the axle seat 66 engages the axle 22 so that the axle surface 23 is in contact with the front axle contact surface 84, the rear axle contact surface 86, and the axle saddle contact surface 90. FIG. 8 specifically shows a rear weld 79 extending around the perimeter of the welding stud 82 along the interface of the welding stud 82 and the axle surface 23. A front weld 78 extends in a similar manner around the perimeter of the welding stud 80 along the interface of the welding stud 80 and the axle surface 23. The axle 22 is rigidly connected to the beam 20 by the welds 78, 79 that traverse the perimeter of each welding stud 80, 82 respectively, along the interface of the welding stud 80, 82 and the axle surface 23. As shown in FIG. 8, the weld 79 is laid down in a counter-clockwise direction, as indicated by the arrow, although it can alternatively be laid down in a clockwise direction. The front weld 78 is fabricated by starting the weld 78 at the front weld cavity 92 and laying down the weld 78 around the welding stud 80, along the interface of the welding stud 80 and the axle surface 23, and returning to the front weld cavity 92 to join the weld starting point. The rear weld 79 is similarly fabricated by starting the weld 79 at the rear weld cavity 94 and laying down the weld 79 around the welding stud 82 along the interface of the welding stud 82 along the interface of the welding stud 82 and the axle surface 23, and returning to the rear weld cavity 94 to join the weld starting point. With a curvature of the axle saddle 88 somewhat greater than the curvature of the axle 22, the top of the axle 22 is in contact with the axle saddle 88 at its junction with the axle saddle stiffening rib 96. This provides for vertical load transfer directly from the axle 22 to the beam 20 without the vertical load being carried by the beam-to-axle welds.

The trailing arm 112 is connected to the hanger bracket 18 by slidably inserting a resilient bushing 52 into the bushing aperture 68 so that the bushing 52 is frictionally retained therein, and utilizing a conventional connection 54, such as a bolted fastener, for the pivotal connection between the trailing arm 112 and the hanger bracket 18. The trailing arm 112 can pivot about the axis 36, and the resilient bushing 52 enables the generally horizontal translation of the trailing arm 112 along its longitudinal axis 34 to differ in degree from its generally vertical translation orthogonal to the axis 34. The air spring 24, the brake actuator assembly 26, the shock absorber assembly 28, wheel assemblies, and other suspension components such as track bars, are attached to the trailing arm 112 and axle 22 in a conventional manner to provide the complete suspension assembly 10.

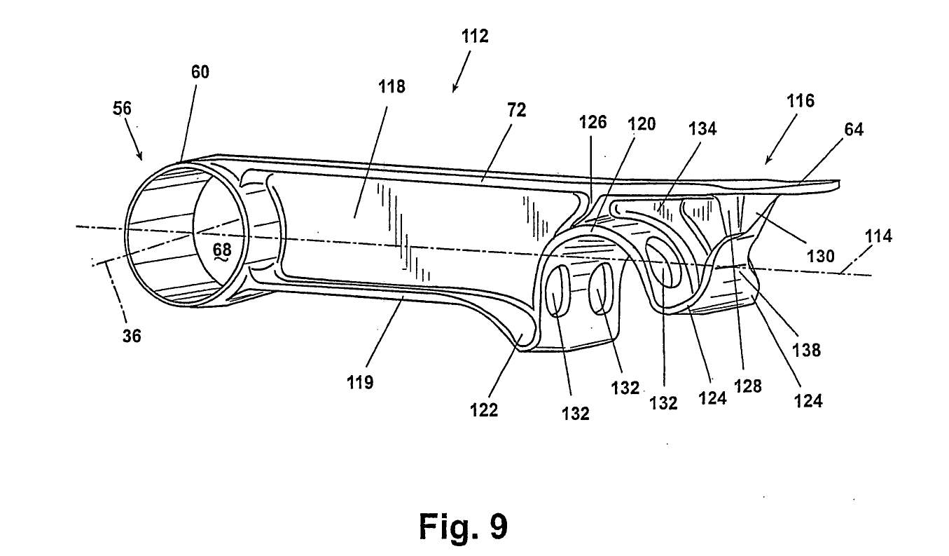

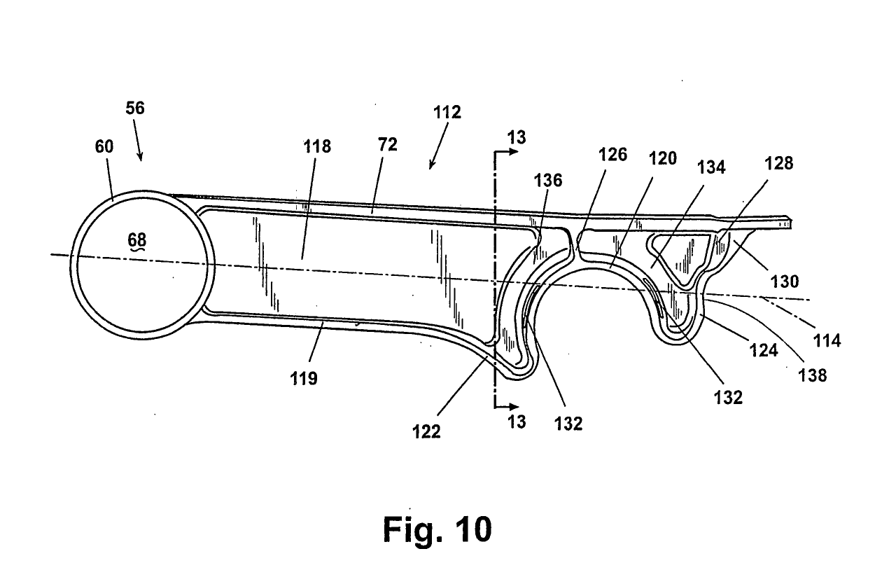

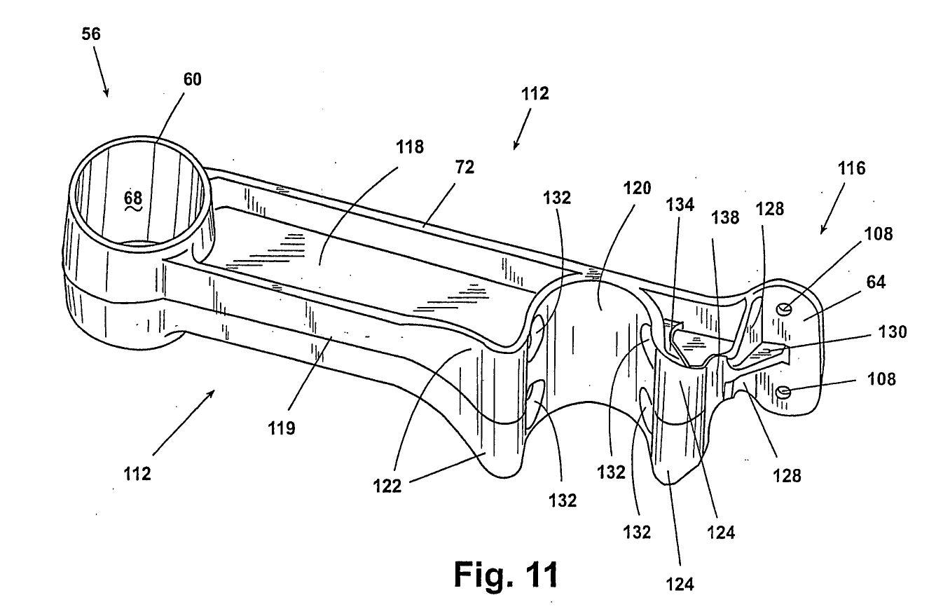

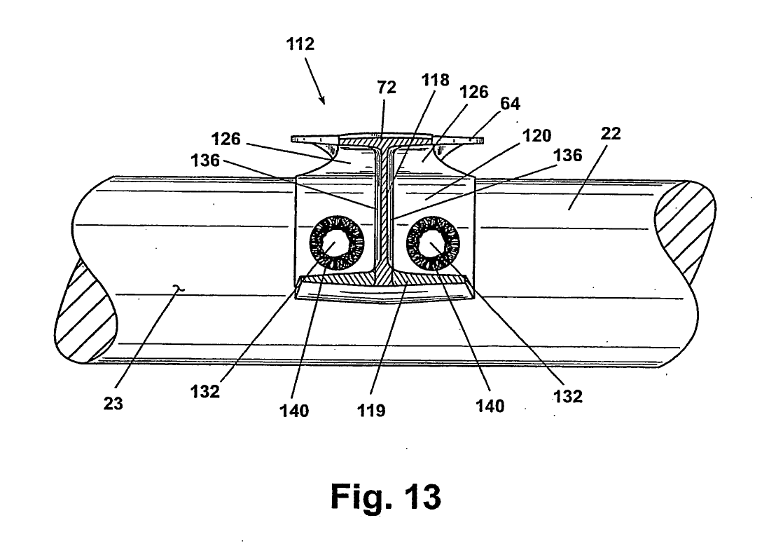

Referring now to FIGS. 9-13, an alternative embodiment of the trailing arm 112 is shown, which is generally like the first embodiment described herein except for the axle seat and adjacent beam configuration. Thus, like numbers will be used to identify like parts. The second embodiment comprises a rigid, generally elongated member having a proximal end 56 with a bushing sleeve 60 and bushing aperture 68, and a distal end 116 with an air spring seat 64. Intermediate the proximal end 56 and the distal end 116 is an I-beam section comprising an upper beam flange 72, a web 118, and lower beam flange 119. The trailing arm 112 defines a longitudinal axis 114.

As shown in FIGS. 9-12, the lower flange 119 terminates in an axle yoke 120 adapted to slidably engage the axle 22. The axle yoke 120 is a generally arcuate, half-cylindrical web preferably extending laterally an equal distance on either side of the longitudinal axis 114. However, the yoke 120 can extend beyond the axis 114 an unequal distance to accommodate the actual stresses to which the yoke 120 will be subjected, or due to other considerations such as providing clearance to accommodate other suspension components or the incorporation of other mounting structures. The embodiment shown in FIGS. 9-12 comprises a yoke 120 having a length that extends laterally beyond the upper flange 72. The finite element analysis method can be utilized in order to precisely configure the thickness and length of the yoke 120 to accommodate the stresses to which the yoke 120 will be subjected.

The lower flange 119 transitions smoothly into the yoke 120 through a pair of laterally-extending gussets 122. The yoke 120 transitions smoothly into an axle seat wing 138 through a pair of laterally-extending gussets 124. The axle seat wing 138 terminates in a pair of laterally-extending air bag seat gussets 128 and an air bag seat rib 130. The air bag seat gussets 128 extend from the web 118 to join the axle seat wing 138 to the air spring seat 64, and extend laterally from the web 118 to the edge of the air spring seat 64 orthogonal to the longitudinal axis 114 of the beam 112. The air bag seat rib 130 extends orthogonally from the air bag seat gussets 128 to join the axle seat wing 138 to the air spring seat 64, and is essentially coplanar with the web 118.

An axle yoke stiffening rib 126 is a generally platelike structure extending orthogonal to the web 118 and joining the yoke 120 to the top flange 72 on either side of the web 118. The thickness of the axle yoke stiffening rib 126 is selected during the design process based upon the stresses to which the rib 126 will be subjected.

The web 118 is selectively thickened to form a rear thickened web portion 134 and a front thickened web portion 136 proximate to the yoke 120. The design process preferably utilizes the finite element analysis method in order to precisely configure the shape and thickness of the thickened web portions 134, 136 to accommodate the stresses to which the thickened web portions 134, 136 will be subjected.

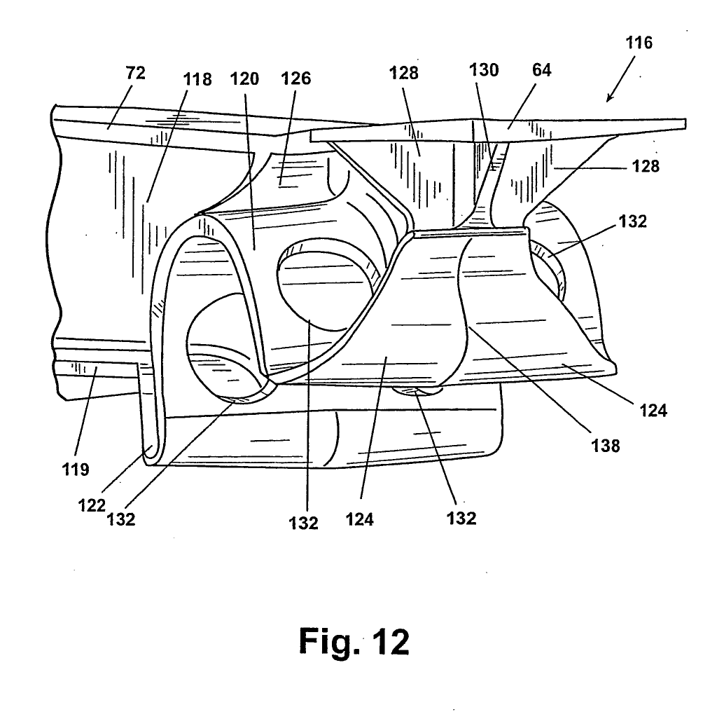

Referring now to FIG. 12, the axle 22 is rigidly connected to the beam 112 by joining the axle 22 with the yoke 120 so that the axle surface 23 is in contact with the inner surface of the yoke 120. Welds 140 are laid down around the circumference of each weld cavity 132 along the interface between the circumference of the weld cavity 132 and the axle surface 23, ending the weld 140 at the point of beginning. The yoke 120 has a radius somewhat larger than the radius of the axle 22 so that the top of the axle 22 is in contact with the yoke 120 at its junction with the axle yoke stiffening rib 126. This provides for vertical load transfer directly from the axle 22 to the beam 112 without carrying the vertical load through the trailing arm-to-axle welds.

The trailing arm 112 is connected to the hanger bracket 18 through a resilient bushing 52 and a conventional fastener 54 as with the first embodiment described herein, and the air spring 24, the brake actuator assembly 26, the shock absorber assembly 28, wheel assemblies, and other suspension components such as track bars, are attached to the beam 112 and axle 22 in a conventional manner to provide the complete suspension assembly 10.

The trailing arm or beam is first analyzed and designed, such as by using finite element analysis methods, to precisely tailor the dimensions at each beam section to the stresses “seen” by the beam at that section. The trailing arm is then fabricated, preferably using a casting process in which the beam mold is prepared to produce a trailing arm having the precise dimensions determined from the finite element analysis method. The trailing arm can also be fabricated by building the trailing arm up from individual welded components or through other methods, such as machining, to provide a beam with as-fabricated dimensions corresponding to the dimensions determined from the design process. Relatively small changes in the dimensions of the trailing arm required during the design process can be readily incorporated in the trailing arm fabricated through the use of the casting method.

As shown in FIGS. 3 and 4, the front welding stud 80 is effectively a continuation of the lower flange 74. As shown in FIGS. 7 and 8, both welding studs 80, 82 enable a continuous weld to be laid down around the front and rear portions of the axle 22, eliminating weld stops and starts on the inboard and outboard sides of the trailing arm 112. With this configuration, the suspension can accommodate the high-axle torque induced by vehicle braking on the outboard side of the beam and the axle torque generated by the resistance of the suspension to vehicle roll while reducing the potential for torque-induced cracking resulting from a weld discontinuity.

The continuity of the welding stud 80 with the lower flange 74 directly transfers and dissipates high lateral loads uniformly into the beam 20 (and ultimately to the tri-functional bushing 52). The varying size and shape of the lower flange 74 more efficiently transfers the lateral loads directly from the welding stud 80 through the rest of the beam 20.

Referring to FIG. 1, the axle 22 carries several primary loading components. One component is the vertical load comprising the weight of the trailer 14 transferred through the axle 22 and into the tires 16. The weight of the trailer 14 is vertically transferred from the trailer frame 12 into the resilient bushing 52 and air spring 24. In order to efficiently transfer the load from the axle 22 through the bushing 52 and air spring 24, the axle seat 66 is designed with a radius larger than the axle radius. Thus, the top of the axle 22 is in direct contact with the axle saddle 88 or axle yoke 120 at the top dead center of the axle 22. As a result, the vertical load is transferred directly into the trailing arm 112 and the beam-to-axle welds support none of the vertical axle loading. The load transferred from the top of the axle 22 is a compressive load at the bottom of the trailing arm 112, and the design provides for effective vertical load transfer into the upper flange 72 of the I-beam portion. The upper flange 72 can readily carry the load into the resilient bushing 52 and air spring 24.

The axle 22 is also subjected to axle torque from load inputs such as braking or vehicle roll. Additionally, the axle 22 is subjected to lateral loads, which must be transferred into the trailing arm 122. The welded beam-to-axle connection directly transfers axle torque and lateral loads to the resilient bushing sleeve 60. Consequently, the resilient bushing 52 must effectively transfer these loads into the suspension frame bracket 18. A conventional I-beam section does not have a varying flange thickness. The varying flange thickness of the I-beam according to the invention is designed to carry these loads in the most efficient manner. Casting or forging the trailing arm 112 provides an economical method of varying the flange thickness.

As shown also in FIG. 6, the lower flange 74 of the I-beam according to the invention effectively extends directly to the welding surface of the axle-to-beam connection, i.e., the stud 80. The flange 74 is designed to accommodate the torque loads by a reduction in thickness and, if desired, width from the axle 22 to the resilient bushing sleeve 60. This thickness reduction is possible because the magnitude of the force to which the trailing arm 112 is subjected due to axle torque decreases as the distance of the force from the axle increases. Efficient transfer of forces to the resilient bushing sleeve 60 is also effected by tying the lower flange 74 directly into the resilient bushing sleeve 60.

Additionally, the axle lateral load must be transferred to the resilient bushing sleeve 60 since the air spring 24 can provide no resistance to lateral load. The lower flange 74 is designed to effectively transfer this load since it is effectively welded to the axle 22 through the welding stud 80. The variation in flange thickness or width is possible because the bending stress to which the flange 74 is subjected decreases in magnitude as the resilient bushing sleeve 60 is approached. The continuity of the connection of the lower flange 74 to the resilient bushing sleeve 60 most efficiently transfers the load from the beam-to-axle welds to the resilient bushing 52. This same design concept enables the efficient transfer of axle torque into the air spring 24.

The invention provides several advantages over the constructions of previous trailing arm suspensions. First, the weight of a suspension assembly utilizing the optimized I-beam is significantly reduced compared to the weight of a suspension assembly utilizing a conventional built-up trailing beam. It is expected that the optimized I-beam utilizing a tri-functional resilient bushing between the trailing arm and frame bracket and welded beam-to-axle connection will weigh less than 60 pounds, a reduction of at least 15 pounds compared to a built-up welded beam utilizing a two-pin resiliently bushed axle-to-beam connection. Second, the beam configuration and weight can be optimized by conforming the dimensions of the beam at any point on the beam to the stresses at that point to which the beam is subjected, and to the stresses to which the axle is subjected. The beam dimensions can be closely controlled by a casting process, thereby configuring the beam to precisely respond to the distribution of stresses along the beam while minimizing excess beam material. Third, the beam-to-axle welded connections described herein will minimize weld-induced stress concentrations in the axle that can lead to premature axle failure. Fourth, the beam-to-axle welded connections described herein facilitate separation of the beam and the axle for replacement of either suspension element, thereby avoiding replacement of the entire suspension system when only a single element must be replaced. Fifth, the beam configuration provides for the most efficient transfer of vertical, lateral, and torque loads from the axle through the resilient trifunctional bushing and the air spring.

While the invention has been specifically described in connection with certain specific embodiments thereof, it is to be understood that this is by way of illustration and not of limitation. Reasonable variation and modification are possible within the scope of the foregoing disclosure and drawings without departing from the spirit of the invention, and the scope of the appended claims should be construed as broadly as the prior art will permit.

1. A suspension system for suspending a vehicle frame above a plurality of ground-engaging wheels, comprising:
a wheel-carrying axle having a first end and a second end;
a pair of frame bracket assemblies operably coupled to opposite sides of the vehicle frame;
a pair of trailing arm assemblies adapted to be mounted to opposite sides of the vehicle frame and operably coupled to the first end and the second end of the axle, respectively, and operably coupled to the frame bracket assemblies, each trailing arm assembly comprising a trailing arm that comprises an I-beam portion having a web section, a first flange and a second flange, wherein a thickness of the first flange varies along a length thereof; and
an axle mounting assembly operably coupling the axle to the trailing arms.

2. The suspension system of claim 1, wherein a thickness of the second flange of each trailing arm varies along a length of the second flange.

3. The suspension system of claim 2, wherein a thickness of the first flange of each trailing arm is greater at a first end, located proximate the axle, than at a second end, located proximate the frame bracket.

4. The suspension system of claim 3, wherein a thickness of the second flange of each trailing arm is greater at a first end, located proximate the axle, than at a second end, located proximate the frame bracket.

5. The suspension system of claim 1, wherein a thickness of the first flange of each trailing arm is greater at a first end, located proximate the axle, than at a second end, located proximate the frame bracket.

6. The suspension system of claim 5, wherein a thickness of the second flange of each trailing arm is greater at a first end located proximate the axle than at a second end located proximate the frame bracket.

7. The suspension system of claim 6, wherein the thicknesses of the first flange and the second flange are selected based upon a determination of design stresses to which the trailing arm is subject to at any point along a length thereof

8. The suspension system of claim 7, wherein the thicknesses of the first flange and the second flange are determined by finite element analysis techniques.

9. The suspension system of claim 1, wherein the trailing arm comprises a single-piece casting.

10. A trailing arm for use in a vehicle suspension system, comprising:
a first end comprising an axle seat adapted to operable couple with a vehicle axle;
a second end adapted to pivotably couple with a hanger bracket;
a longitudinally extending first flange having a thickness that varies along a length thereof;
a longitudinally extending second flange; and
a web section extending between and substantially orthogonal to the first flange and the second flange.

11. The trailing arm of claim 10, wherein a thickness of the second flange of each trailing arm varies along a length of the second flange.

12. The trailing arm of claim 11, wherein a thickness of the first flange is greater at the first end than at the second.

13. The trailing arm of claim 12, wherein a thickness of the second flange is greater at the first end than at the second end.

14. The trailing arm of claim 13, wherein the trailing arm is a single-piece casting.

15. The trailing arm of claim 10, wherein a thickness of the first flange is greater at the first end than at the second.

16. The trailing arm of claim 15, wherein a thickness of the second flange is greater at the first end than at the second end.

17. The trailing arm of claim 16, wherein the thicknesses of the first flange and the second flange are selected based upon a determination of design stresses to which the trailing arm is subject to at any point along a length thereof.

18. The trailing arm of claim 17, wherein the thicknesses of the first flange and the second flange are determined by finite element analysis techniques.

19. The trailing arm of claim 10, wherein the trailing arm comprises a single-piece casting.

20. A suspension system for suspending a vehicle frame above a plurality of ground-engaging wheels, comprising:
a wheel-carrying axle having a first end and a second end;
a pair of frame bracket assemblies operably coupled to opposite sides of the vehicle frame;
a pair of trailing arm assemblies, each trailing arm assembly adapted to be mounted to opposite sides of the vehicle frame and operably coupled to the first end and the second end of the axle, respectively, and operably coupled to the frame bracket assemblies, trailing arm assembly comprising a trailing arm comprising an I-beam portion having a web section, a first flange and a second flange; and
an axle mounting assembly comprising at least one welded trailing arm-to-axle connection.

21. The suspension system of claim 20, wherein the at least one welded trailing arm-to-axle connection comprises at least one weld stud.

22. The suspension system of claim 21, wherein the at least one weld stud is adapted to accommodate a weld extending around a perimeter of the at least one weld stud, such that the weld begins and ends at a same point along the perimeter of the at least one weld stud.

23. The suspension system of claim 22, wherein the at least one weld stud includes a pair of juxtaposed welding studs extending substantially orthogonally from the web section of the trailing arm.

24. The suspension system of claim 23, wherein the trailing arm comprises a single-piece casting.

25. The suspension system of claim 20, wherein the at least one weld stud includes a pair of juxtaposed welding studs extending substantially orthogonally from the web section of the trailing arm.

26. The suspension system of claim 20, wherein the trailing arm comprises a single-piece casting.

27. The suspension system of claim 26, wherein the axle seat of the trailing arm comprises at least one weld aperture extending therethrough and defining a weld edge, and wherein the weld edge is adapted to accommodate a weld extending therealong.

28. A trailing arm for use in a vehicle suspension system, comprising:
a first end comprising an axle seat adapted to be directly attached to a vehicle axle;
a second end adapted to pivotably couple with a hanger bracket; and
an I-beam portion having a longitudinally extending first flange, a longitudinally extending second flange, and a web section extending between and substantially orthogonal to the first flange and the second flange.

29. The trailing arm of claim 28, wherein the axle seat is adapted to be welded directly to the axle of the vehicle suspension system.

30. The trailing arm of claim 29, wherein the trailing arm further comprises at least one weld stud.

31. The trailing of claim 30, wherein the at least one weld stud is adapted to accommodate a weld extending around a perimeter of the at least one weld stud, such that the weld begins and ends at a same point along the perimeter of the at least one weld stud.

32. The trailing arm of claim 31, wherein the at least one weld stud includes a pair of juxtaposed welding studs extending substantially orthogonally from the web section.

33. The trailing arm of claim 32, wherein the trailing arm further comprises a single-piece casting.

34. The trailing arm of claim 28, wherein the trailing arm further comprises a single-piece casting.

35. The trailing arm of claim 34, wherein the axle seat comprises at least one weld aperture extending therethrough and defining a weld edge, and wherein the weld edge is adapted to accommodate a weld extending therealong.

36. A suspension system for suspending a vehicle frame assembly above a plurality of ground-engaging wheels, the vehicle frame assembly including an external dock lock assembly operable between a storage position and an in-use position, the suspension system comprising:
a wheel-carrying axle having a first end and a second end;
a pair of frame bracket assemblies operably coupled to opposite sides of the vehicle frame; and
a pair of trailing arm assemblies, each trailing arm assembly adapted to be mounted to opposite sides of the vehicle frame and operably coupled to the first end and second end of the axle, respectively, each trailing arm assembly operably coupled to the frame bracket assemblies, respectively, each trailing arm assembly comprising a trailing arm that comprises:
a longitudinally extending first flange;
a longitudinally extending second flange; and
a web section extending between the first flange and the second flange and having a structurally reinforced section positioned along a length of the trailing arm such that the external dock lock abuts the trailing arm proximate the structurally reinforced section when the external dock lock is in the in-use position.

37. The suspension system of claim 36, wherein the web section of the trailing arm comprises a first thickness along a length thereof and the structurally reinforced section comprises a second thickness extending along a length of the web section, and wherein the second thickness being greater than the first thickness.

38. The suspension system of claim 37, wherein the structurally reinforced section is located beneath the external dock lock when the external dock lock is in the in-use position.

39. The suspension system of claim 38, wherein the trailing arm comprises a single-piece casting.

40. The suspension system of claim 36, wherein the structurally reinforced section is located beneath the external dock lock when the external dock lock is in the in-use position.

41. The suspension system of claim 36, wherein the trailing arm comprises a single-piece casting.

42. The suspension system of claim 36, wherein the trailing arm comprises a single-piece casting.

43. A trailing arm for use in a vehicle suspension system for suspending a vehicle frame assembly above a plurality of ground-engaging wheels, the vehicle frame assembly including an external dock lock assembly operable between a storage position and an in-use position, the trailing arm comprising:
a first end comprising an axle seat adapted to operably couple with a vehicle axle;
a second end adapted to pivotably couple with a hanger bracket;
a longitudinally extending first flange;
a longitudinally extending second flange; and
a web section extending between the first flange and the second flange and having a structurally reinforced section positioned along a length of the trailing arm such that the external dock lock abuts the trailing arm proximate the structurally reinforced section when the external dock lock is in the in-use position.

44. The trailing arm of claim 43, wherein the web section comprises a first thickness along a length thereof and the structurally reinforced section comprises a second thickness extending along a length of the web section, and wherein the second thickness is greater than the first thickness.

45. The trailing arm of claim 44, wherein the structurally reinforced section is located beneath the external dock lock when the external dock lock is in the in-use position.

46. The trailing arm of claim 45, wherein the trailing arm comprises a single-piece casting.

47. The trailing arm of claim 43, wherein the structurally reinforced section is located beneath the external dock lock when the external dock lock is in the in-use position.

48. The trailing arm of claim 47, wherein the trailing arm comprises a single-piece casting.

49. A suspension system for suspending a vehicle frame assembly above a plurality of ground-engaging wheels, the vehicle frame assembly including an external dock lock assembly operable between a storage position and an in-use position, the suspension system comprising:
a wheel-carrying axle having a first end and a second end;
a pair of frame bracket assemblies operably coupled to opposite sides of the vehicle frame; and
a pair trailing arms, comprising:
a first end comprising an axle seat that is directly connected to the axle;
a second end adapted to pivotably couple with the hanger bracket;
a longitudinally extending first flange, wherein a thickness of the first flange varies along a length thereof;
a longitudinally extending second flange, wherein a thickness of the second flange varies along a length thereof; and
a web section extending between the first flange and the second flange and having a structurally reinforced section positioned along a length of the trailing arm such that the external dock lock abuts the trailing arm proximate the structurally reinforced section when the external dock lock is in the in-use position; and
wherein each trailing arm further comprises a single-piece casting.
